(19) United States
(12) Patent Application Publication
(10) Pub. No.: US 2008/0212116 A1
(43) Pub. Date: Sep. 4, 2008

(54) IMAGE PROCESSING APPARATUS, IMAGE PROCESSING METHOD, AND COMPUTER-READABLE RECORDING MEDIUM

(76) Inventor: Masateru Kumagai, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/035,754

(22) Filed: Feb. 22, 2008

(30) Foreign Application Priority Data
Mar. 2, 2007 (JP) 2007-053289

(51) Int. Cl. G06F 15/00

(52) U.S. Cl. 358/1.9

(57) ABSTRACT

An image processing apparatus includes plural output processing units one for each of different image output units and an input processing unit that processes image data input from an image input unit to output an image in an image format compatible with one of the image output units.

### BACKGROUND OF THE INVENTION

1. Field of the Invention

The preset invention relates to an image processing apparatus, an image processing method, and a computer-readable recording medium.

2. Description of the Related Art

In order to shorten the development period of and reduce the cost of image processing apparatuses that support plural image output units, some image processing apparatus include an integrated unit that covers operations from input to output of images.

For example, Japanese Registered Patent No. 3679349 (Patent Document 1) discloses an image forming apparatus in which a control program shared by plural applications comprises plural modules. In the image forming apparatus disclosed in Patent Document 1, an image input from a PC (personal computer) is processed by plural applications corresponding to plural image output units such as a plotter, a facsimile device, and a network communication device. These applications use the modules to execute their operations.

A problem with the image forming apparatus of Patent Document 1 is that, because each module includes interfaces one for each of associated applications, every time one of the applications is modified or a new application is added to perform a job, it is necessary to modify the modules associated with the added or modified application and then modify the applications associated with the modified modules.

Furthermore, the technique disclosed in Patent Document 1 does not focus on the formats of images to be processed by the image forming apparatus. That is, in the case where plural image output units such as a plotter and a facsimile device are provided of which compatible image formats are different from each other, an input image is transformed into an image format compatible with the plotter and then transformed into an image format compatible with the facsimile device, so that the quality of the image may be reduced.

### SUMMARY OF THE INVENTION

In view of the forgoing, the present invention is directed to an image processing apparatus that processes an image into an image format compatible with one of image output units, thereby maintaining the quality of the image and allowing easy addition and modification of functions; an image processing method; and a computer-readable recording medium storing a program.

In one embodiment of the present invention, there is provided an image processing apparatus that includes plural output processing units one for each of different image output units; and an input processing unit that processes image data input from an image input unit to output an image in an image format compatible with one of the image output units. With this configuration, it is possible to maintain image quality and easily add or modify a function to the image processing apparatus.

In one embodiment of the present invention, there is provided an image processing method that includes an input processing step of processing input image data to output an image in an image format compatible with one of different image output units; and an output processing step of outputting the image to said one of the image output units.

In one embodiment of the present invention, there is provided a computer-readable recording medium storing a program that includes computer-executable instructions for executing an image processing method. The image processing method includes an input processing step of processing input image data to output an image in an image format compatible with one of different image output units; and an output processing step of outputting the image to said one of the image output units.

According to an aspect of the present invention, an image processing apparatus is provided that processes an image into an image format compatible with one of image output units, thereby maintaining the quality of the image and allowing easy addition and modification of functions.

### BRIEF DESCRIPTION OF THE DRAWINGS

FIG. 1 is a block diagram illustrating a configuration of component units of an image processing apparatus that executes jobs according to an embodiment of the present invention;

FIG. 2 is a conceptual diagram illustrating the pipes & filters architecture;

FIG. 3 is a block diagram illustrating an exemplary functional configuration of an image processing apparatus according to an embodiment of the present invention;

FIG. 4 is a conceptual diagram illustrating the process of selecting filters and constituting a job;

FIG. 5 is a diagram showing an example of a request described in a page description language;

FIG. 6 is a sequence diagram showing the process of starting reception of a request by a PC document receiving filter;

FIG. 7 is a sequence diagram showing the process in which a request management unit creates a job tree;

FIG. 8 is a sequence diagram showing the process of executing a print job according to a created job tree;

FIGS. 9A and 9B are diagrams each illustrating the process of transforming an input image into an image format(s) compatible with an image output unit(s);

FIG. 10 is a diagram illustrating an operation of combining images;

FIG. 11 is a diagram showing an example of a screen that prompts a user to select an image input unit and an image output unit;

FIGS. 12 and 13 are flowcharts each illustrating the process of determining the content of a job; and

FIG. 14 is a diagram showing the configuration of a computer as an image processing apparatus of an embodiment of the present invention.

### DETAILED DESCRIPTION OF THE PREFERRED EMBODIMENT

In the following, preferred embodiments of the present invention are described with reference to the accompanying drawings.

### First Embodiment

(An Exemplary Configuration of Component Units of an Image Processing Apparatus of an Embodiment of the Present Invention that Execute Jobs)

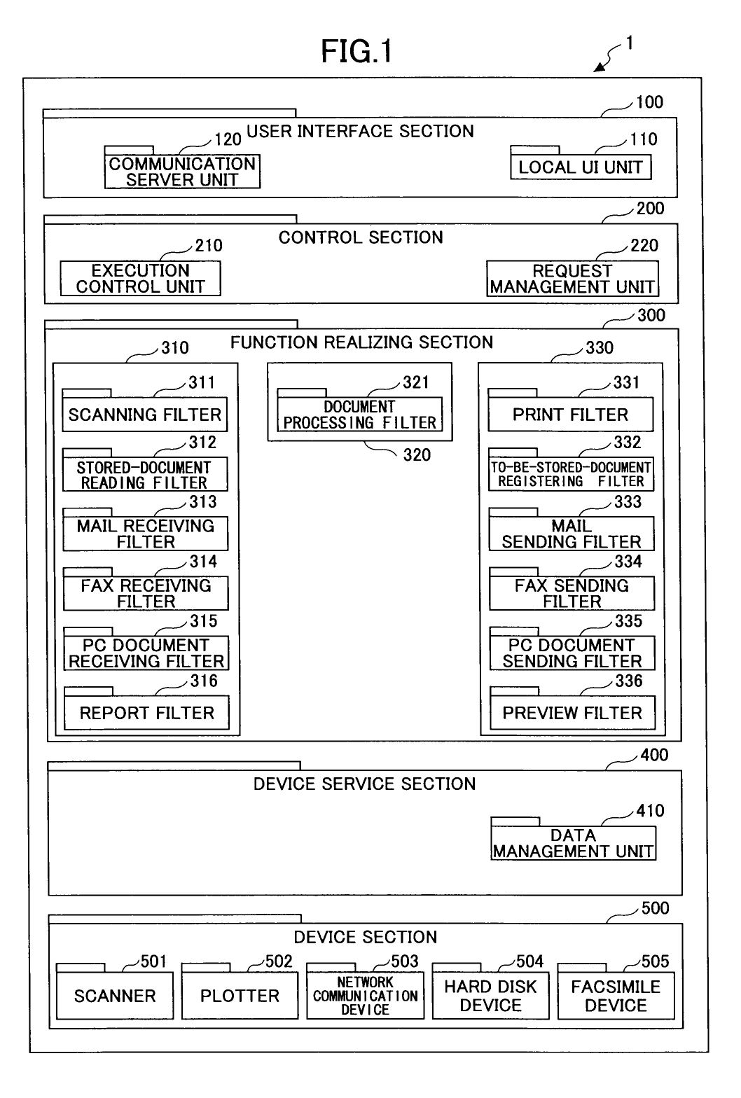

FIG. 1 is a block diagram illustrating an exemplary configuration of component units of an image processing apparatus that executes jobs according to an embodiment of the present invention. More specifically, FIG. 1 illustrates an exemplary software configuration of an MFP (multifunction processing machine) 1 as an image processing apparatus that performs jobs. The MFP 1 is an image forming apparatus that includes multiple functions such as printer, copier, scanner, and facsimile functions in one physical body.

With reference to FIG. 1, the software of the MFP 1 includes a user interface section 100, a control section 200, a function realizing section 300, a device service section 400, and a device section 500. The hierarchical relationship between these sections of FIG. 1 is based on the call relationship between the sections. That is, generally, an upper section calls a lower section in the drawing.

The user interface section 100 has a function for receiving requests for execution of jobs (e.g., copy, print, scan, and facsimile transmission), and includes a local UI (user interface) unit 110 and a communication server unit 120, for example. The local UI unit 110 receives requests input from a not-shown operations panel, for example. The communication server unit 120 receives requests input from not-shown client PCs via a network, for example. The requests received by the user interface section 100 are transmitted to the control section 200.

The control section 200 has a function for controlling operations for executing a requested job. The control section 200 includes, for example, an execution control unit 210 and a request management unit 220. The execution control unit 210 controls execution of operations included in a job. The execution control unit 210 controls operations to be performed by component units of the function realizing section 300 and further controls operations to be performed by device drivers (not shown) of the device section 500.

The request management unit 220 selects filters, which are provided in the function realizing section 300, according to a requested job and connects the selected filters to one another, thereby creating a logical framework of the job. To create a logical framework of a job is to determine operations to be executed for performing the job, determine the order of execution of the operations, and associate processing units that perform these operations with the execution control unit 210 that controls the processing units.

Job requests to the request management unit 220 may include, other than instructions that are input from the local UI unit 110, an instruction for an output operation by a printer output that is input from the communication server unit 120 from a PC via a network, for example.

In the following description, “a job of the MFP 1” refers to a single unit of service (from when a request is input until when a resulting output is provided) to be provided to a user by the MFP 1. In terms of software, “a job of the MFP 1” refers to an application that provides a single unit of service.

The function realizing section 300 includes a group of processing units, each of which performs a part of a job of the MFP 1. The processing units in the function realizing section 300 are selectively combined to perform a job. In the following description, each of the processing units is called a “filter”. This is because the software for executing jobs of the MFP 1 is based on a software architecture called “pipes & filters”.

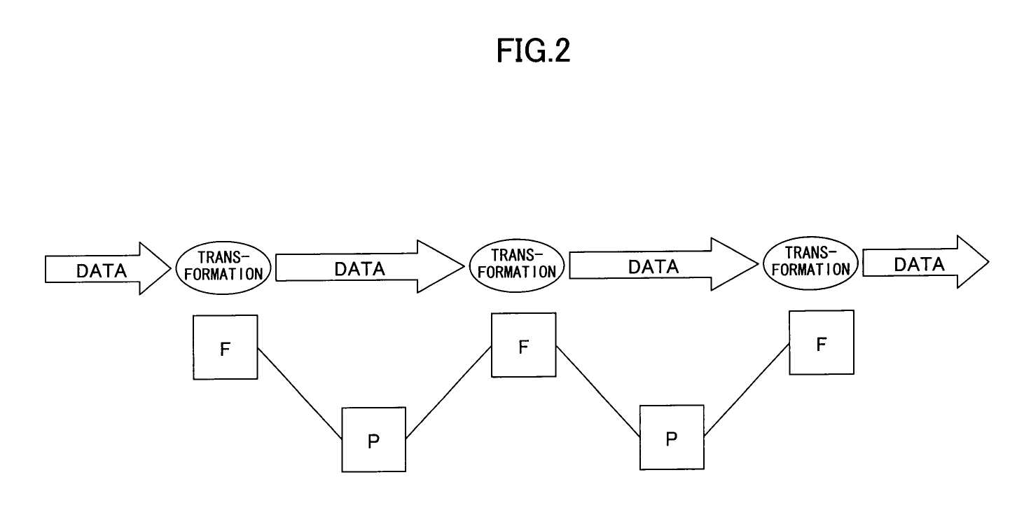

FIG. 2 is a conceptual diagram illustrating the pipes & filters architecture. In FIG. 2, “F” indicates a filter, and “P” indicates a pipe. As shown in FIG. 2, pipes interconnect filters. A filter transforms input data and outputs the transformed data. Then a pipe passes the output data to the next filter.

Each function, i.e., a job, of the MFP 1 of this embodiment is regarded as a series of transformation operations on data (e.g., a document). Each job of the MFP generally includes a data input operation, a data processing operation, and a data output operations. Each of the input, processing, and output operations are regarded as a single transformation operation, and a software component that performs a single transformation operation is embodied as a filter. The filters are independent from each other. That is, the filters basically do not have a dependency relationship (call relationship) between them. Accordingly, the filters may be independently added to (installed into) or removed from (uninstalled from) the MFP 1.

Referring back to FIG. 1, the function realizing section 300 includes plural filters. More specifically, the function realizing section 300 includes an input filter 310 for input operations, a processing filter 320 for processing operations, and an output filter 330 for output operations. The input filter 310 includes plural filters one for each image input unit, and analyzes input image data. With this configuration, it is easy to add a function to and modify a function of each image input unit. The output filter 330 includes plural filters one for each image output unit.

More specifically, the input filter 310 includes a scanning filter 311, a stored-document reading filter 312, a mail receiving filter 313, a facsimile receiving filter 314, a PC document receiving filter 315, and a report filter 316.

The scanning filter 311 controls scanning of image data by a scanner 501 (described below), and outputs the scanned image data. The stored-document reading filter 312 reads document data stored in a storage unit of the MFP 1, and processes the read data. The document data may include text data and image data.

The mail receiving filter 313 receives e-mail and processes data contained in the e-mail. The facsimile receiving filter 314 controls facsimile reception and processes the received printed data.

The PC document receiving filter 315 receives instructions for a print job, a facsimile transmission, and the like, and analyzes the instructions. The report filter 316 transforms configuration information and history information of the MFP 1 into, e.g., tabular data.

The processing filter 320 includes a document processing filter 321. The document processing filter 321 performs image transformation operations (combining, scaling, etc.) on the input data.

The output filter 330 includes a print filter 331, a to-be-stored-document registering filter 332, a mail sending filter 333, a facsimile sending filter 334, a PC document receiving filter 335, and a preview filter 336.

The print filter 331 outputs the input data to a plotter 502 (described below) so that the plotter 502 outputs (prints out) the data. The to-be-stored-document registering filter 332 stores the input data in a storage unit, e.g., a hard disk device 504 (described below), of the MFP 1. The mail sending filter 333 sends the input data in the form of e-mail. The facsimile sending filter 334 sends the input data by facsimile. The PC document sending filter 335 sends the input data as a PC document. The preview filter 336 causes, via the local UI unit 110, the operations panel (not shown) to show a preview of the input data.

The device service section 400 includes a lower-level function, e.g., a pipe function for interconnecting filters that constitute a job, which is commonly used by the filters of the function realizing section 300.

The device section 500 includes devices, such as the scanner 501, a plotter 502, a network communication device 503, the hard disk device 504, and a facsimile device 505, and control units provided one for each of these devices for controlling the corresponding devices.

The scanner 501 scans an image to obtain image data. The plotter 502 prints (outputs) an image. The network communication device 503 receives images from a PC, etc., and sends images to a PC, etc., via a network. The hard disk device 504 stores a large amount of data such as image data. The facsimile device 505 sends and receives images by facsimile.

In the example shown in FIG. 1, the scanner 501 serves as an image input unit, images input to which are processed by the scanning filter 311. The plotter 502 serves as an image output unit, images to be output from which are processed by the print filter 331.

Each of the network communication device 503, the hard disk device 504, and the facsimile device 505 serves as an image input unit and an image output unit. The network communication device 503 corresponds to, e.g., the PC document receiving filter 315 and the PC document sending filter 335. The network communication device 503 may correspond to the mail receiving filter 313 and the mail sending filter 333.

The hard disk device 504 corresponds to the stored-document reading filter 312 and the-to-be-stored-document registering filter 332. The facsimile device 505 corresponds to the facsimile receiving filter 314 and the facsimile sending filter 334.

(An Exemplary Functional Configuration of an Image Processing Apparatus of an Embodiment of the Present Invention)

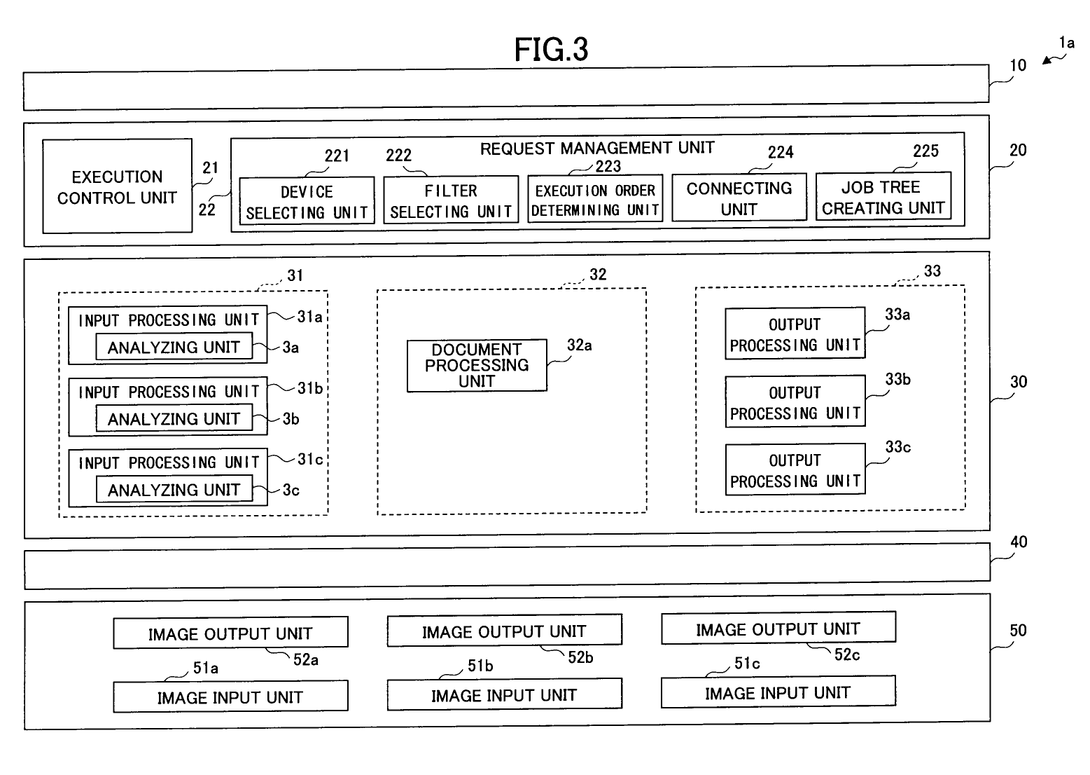

FIG. 3 is a block diagram illustrating an exemplary functional configuration of an image processing apparatus 1a (e.g. the MFP 1 of FIG. 1) according to an embodiment of the present invention. The image processing apparatus 1a of FIG. 3 is configured to process input image data, and output an image in an image format compatible with an image output unit.

The image processing apparatus 1a includes a user interface section 10, a control section 20, a function realizing section 30, a device service section 40, and a device section 50. The user interface section 10 includes a component unit (not shown) with which a user inputs an instruction for a job.

The control section 20 manages jobs to be performed by the image processing apparatus 1a. The control section 20 includes, for example, an execution control unit 21 and a request management unit 22. The execution control unit 21 controls the processing units that perform operations included in a job of the image processing apparatus 1a.

The request management unit 22 selects processing units for executing a job according to a requested, i.e., a job instruction, and logically connects the selected processing units, thereby enabling execution of the job. The processing units are logically connected to perform a series of operations on image data by inputting image data processed by a filter to the next filter according to a filter execution order.

The request management unit 22 includes, e.g., a device selecting unit 221, a filter selecting unit 222, an execution order determining unit 223, a connecting unit 224, and a job tree creating unit 225.

The device selecting unit 221 selects devices to be activated for performing a job. For instance, to perform a copy job, the device selecting unit 221 selects a scanner and a plotter. To perform a document print job requested from a PC, the device selecting unit 221 selects a network communication unit and a plotter.

With this configuration, it is possible to process an image into an image format compatible with an image output unit selected by the device selecting unit 221.

The filter selecting unit 222 selects processing units that execute operations included in a job according to an analyzed request. The execution order determining unit 223 determines the order of execution of the operations of the processing units. The connecting unit 224 interconnects the processing units such that an output from a first processing unit is input to the next processing unit in the order of execution. For instance, the connecting unit 224 causes image data processed and output by an input filter 31 (described below) to be input to a processing filter 32 (described below), thereby connecting the input filter 31 to the processing filter 32. Further, the connecting unit 224 causes image data processed and output by the processing filter 32 to be input to an output filter 33 (described below), thereby connecting the processing filter 32 to the output filter 33. The filters may be interconnecting by using, e.g., a memory as a pipe.

The job tree creating unit 225 creates a logical framework of a job, i.e., a job tree, by connecting the processing units selected by the filter selecting unit 222 to the execution control unit 21.

The function realizing section 30 includes the processing units that perform operations included in a job of the image processing apparatus 1a. In the following description, each of the processing units of the function realizing section 30 is called a “filter”. The function realizing section 30 includes, for example, an input filter 31 for image input units, a processing filter 32 for processing images, and an output filter 33 for image output units.

For example, the input filter 31 includes input processing units 31a-31c. The input processing units 31a-31c are filters corresponding to different image input units. Each of the input processing units 31a-31c is configured to process input image data to obtain (output) an image in an image format compatible with the corresponding image output unit.

For example, the input processing units 31a-31c may obtain an image from image data described in a PDL (Page Description Language) by performing a drawing operation such as a rendering operation. The input processing units 31a-31c may obtain an image by decompressing compressed image data.

For example, the input processing units 31a-31c obtain images in an image format represented in the RGB color space. The RGB color space is a color system that represents colors in three dimensions with the values of three colors, namely, red, green, and blue. The image format of the RGB color space (hereinafter referred to as an “RGB image format”) is used for facsimile communications, PC communications via a network, and mail transmission. Transforming data into such an image format that can be commonly used by plural image output units allows, e.g., the processing filter 32 to be commonly used in plural job, resulting in an increase in the reusability of the image.

A network communication device and a facsimile device each serve as an image output unit and facsimile devices. Processing image data into an image format compatible with these image output units increases the reusability of the image data.

The RGB image format is often used by applications for PCs. Accordingly, image data input from PCs are often in the RGB image format. Using the image without changing the image format upon execution of a job of the image processing apparatus 1a allows the image to maintain its quality.

Examples of versatile image formats include RGB image formats, image formats of the YCbCr color space, and image formats of the YUV color space based on luminance and color difference.

The input processing units 31a-31c may output images in a lossy compressed image format. Because the amount of data is reduced by lossy compression, an image in a lossy compressed image format is preferable for network communication and mail transmission.

Further, the input processing units 31a-31c may obtain images in an image format of the CMYK color space, for example. The CMYK color space is a color system that represents colors with the values of four colors, namely, cyan, magenta, yellow, and black. The image format of the CMYK color format is used, for example, by plotters. Therefor, in the case of outputting an image to a plotter, if the input image is transformed into a CMYK image format, it is possible to quickly perform operations from processing to output of the image, resulting in an increase in the productivity of the image processing.

In the case where the input image is in an image format compatible with a plotter, the image processing apparatus 1a loads the image into the plotter or a hard disk device. This is because as follows. The plotter is an image output unit, and does not include an image input function. Therefore, the image format used by the plotter does not provide versatility. Such an image format may be a result of a conversion from a versatile image format. If the image is transformed again into a versatile format, the image quality is substantially reduced.

In one embodiment of the present invention, when the image output unit outputs an image in an image format compatible with predetermined one of the image output units, the device selecting unit 221 selects the predetermined one of the image output units. With this configuration, when the image output unit outputs an image in an image format compatible with predetermined one of the image output units, it is possible to output an image from the predetermined one of the image output units.

The predetermined one of the image output unit may be a plotter, and the image format compatible with the predetermined one of the image output units may be a CMYK image format or a non-compressed image format. With this configuration, if an image is in an image format compatible with a plotter, it is possible to output the image from the plotter.

The input processing units 31a-31c include analyzing units 3a-3c, respectively. The analyzing units 3a-3c analyze image data input from the image input units corresponding to the image processing units 31a-31c to obtain processing conditions for processing images and/or image information. For example, the analyzing units 3a-3c analyze job instructions described in a PDL. Further, the analyzing units 3a-3c obtain image information from the job instructions described in the PDL, and draw images according to the image information. If the image information is compressed, the analyzing units 3a-3c decompress the image information to obtain images.

The processing filter 32 is configured to process an input image. The provision of the processing filter 32 allows processing of an image into an image format compatible with an image output unit. The processing filter 32 includes a document processing unit 32a. The document processing unit 32a combines images output from plural of the input processing units 31a-31c to generate a single composite image, for example. The document processing unit 32a may perform this operation if the input images are in the same image formats, and may output a composite image in the same image format as the image format of the input images. The document processing unit 32a may include a filter for rotating images, and/or a filter for scaling images.

The document processing unit 32a may be provided one for each of the image output units and configured to process an image into an image format compatible with the corresponding image output unit. With this configuration, images can be input to the processing filters regardless of the image formats of the images, allowing simplifying the configuration of the image processing apparatus 1a. For example, the operation for selecting processing filters by the filter selecting unit 222 of the request management unit 22 can be simplified.

The output filter 33 includes, e.g., output processing units 33a-33c. The output processing units 33a-33c are filters corresponding to different image input units. Each of the output processing units 33a-33c is configured to process an image in an image format compatible with the corresponding image output unit and outputs the image to the image output unit.

If the output processing units 33a-33c correspond to a plotter, the output processing units 33a-33c process an image in an image format of the CMYK image format. If the output processing units 33a-33c correspond to the facsimile device, the output processing units 33a-33c process images in an RGB image format. If the output processing units 33a-33c correspond to the hard disk unit, the output processing units 33a-33c process images in an RGB image format and/or a CMYK image format.

The device service section 40 interconnects the input filters 31 or the output filter 33 and the device section 50 for enabling image transmission there between. Further, the device service section 40 interconnects the filters of the function realizing section 30 for enabling image transmission therebetween.

The device section 40 includes plural pairs of an image input/output device and a device driver for controlling the image input/output device. The device section 50 includes, e.g., image input units 51a-51c and image output units 52a-52c.

Although the MFP 1 of FIG. 1 and the image processing apparatus 1a of FIG. 3 include the device section 500 and the device section 50, respectively, embodiments of the present invention are not limited thereto. For example, the input/output devices may be configured to be connected to an image processing apparatus of an embodiment of the present invention.

(The Process of Selecting Filters and Constituting a Job)

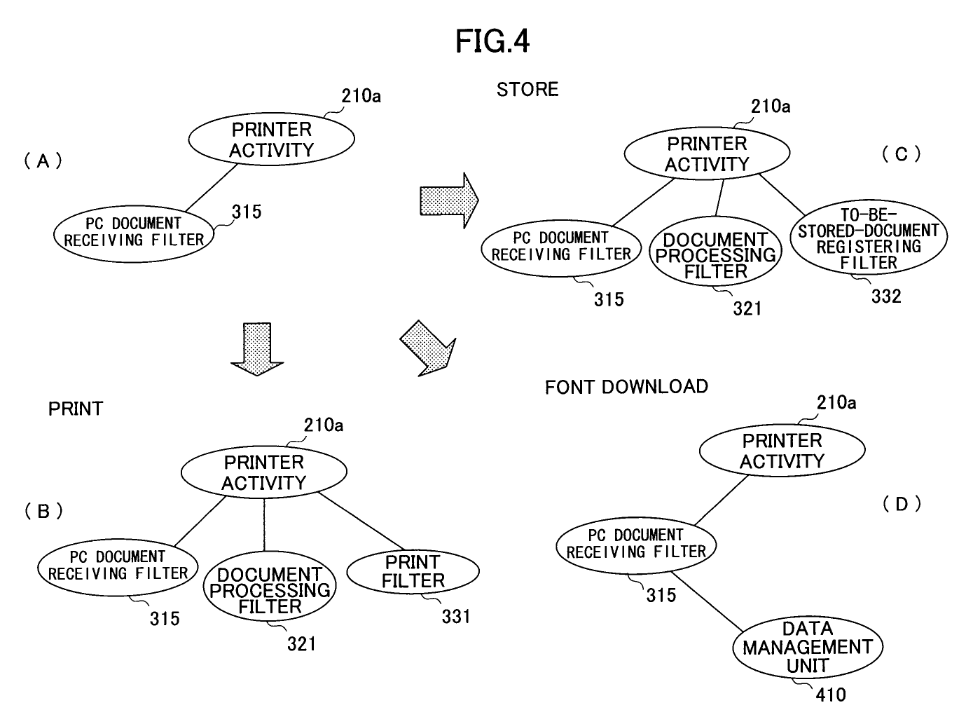

FIG. 4 is a conceptual diagram illustrating the process of creating a job tree for a job to be performed by, e.g., the MFP 1 according to an embodiment of the present invention. With reference to FIG. 4, the filter selecting unit 222 selects filters. The execution order determining unit 223 determines the execution order of the selected filters. The connecting unit 224 interconnects the filters. Then, the job tree creating unit 225 creates a job tree.

A printer activity 210a of FIG. 4 corresponds to the execution control unit 210 of FIG. 1.

In FIG. 4-(A), according an input request, i.e., a job instruction, the PC document receiving filter 315 is connected to the printer activity 210a. FIG. 4-(A) shows the status in which a part of the job tree is created according to a part of an input request analyzed by the PC document receiving filter 315.

In the case where the request is for a print job, with the progress in the analysis of the request by the analyzing unit 3, the document processing filter 321 and the print filter 331 are selected by the filter selecting unit 222 and connected to the printer activity 210a by the job tree creating unit 225, so that the job tree is expanded as shown in FIG. 4-(B). Further, the execution order determining unit 223 determines the filter execution order according to the request. The connecting unit 224 interconnects the PC document receiving filter 315, the document processing filter 321, and the print filter 331. The connecting unit 224 transmits image data obtained and processed by the PC document receiving filter 315 to the document processing filter 321 through the device service section 400. The connecting unit 224 further transmits the image data processed by the document processing filter 321 to the print filter 331 through the device service section 400. In this way, the connecting unit 224 establishes connections between plural filters using the device service section 400 as a pipe.

In the case where the request is for storing a document in the hard disk device 504, the job tree is expanded as shown in FIG. 4-(C). In the job tree shown in FIG. 4-(C), the PC document receiving filter 315, the document processing filter 321, and the stored-document registering filter 332 are selected by the filter selecting unit 222 and are connected to one another by the connecting unit 224 in the execution order.

In the case where the request is for downloading a font from a PC, the job tree is expanded as shown in FIG. 4-(D). In the job tree shown in FIG. 4-(D), the PC document receiving filter 315 is connected to a data management unit 410. Because the data management unit 410 is not a filter provided in the function realizing section 300, but is provided in the device service section 400, the PC document receiving filter 315 and the data management unit 410 are located in the different positions in the vertical direction in FIG. 4-(D).

(An Example of a Request Described in a PDL)

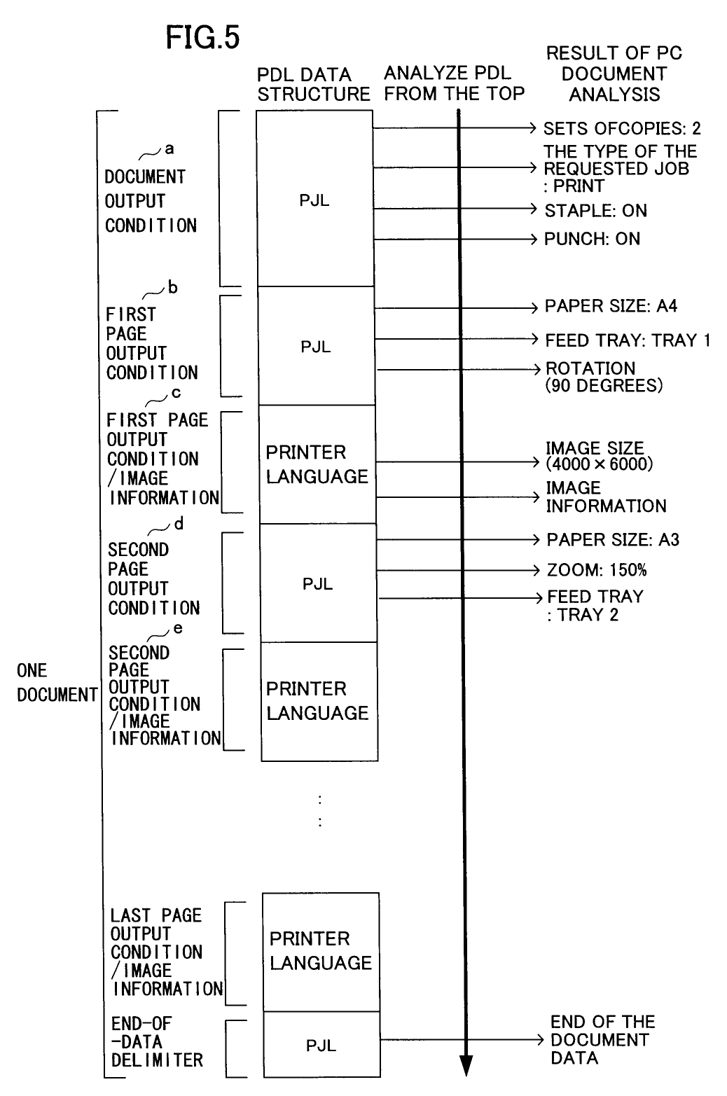

FIG. 5 is a diagram illustrating a request input in, e.g., the MFP 1 according to an embodiment of the present invention. The request shown in FIG. 5 is described in a PDL. The PC document receiving filter 315 analyzes the request of FIG. 5, and then the request management unit 220 creates a job tree.

The request shown in FIG. 5 sequentially includes, from the top, a “document output condition a” described in a printer job language (PJL), a “first page output condition b” in the PJL, and “first page output condition/image information c” described in a printer language. The “first page output condition/image information c” is followed by a “second page output condition d” and a “second page output condition/image information”. In the same manner, an output condition and an output condition/image information of each of the following pages until the last page are alternately arranged. The output condition/image information of the last page is followed by a delimiter described in the PJL, indicating the end of the data.

The document output condition a may include the following items: the number of sets of copies, double-side/single-side printing, ON/OFF of a staple (post-processing) option, the staple position and direction, ON/OFF of a cover page option, ON/OFF of a slip sheet option, sort/stack output, staple/punching, ON/OFF of a toner save mode, priority feed trays, and the number of colors (full color/gray scale).

The document output condition a may further include items such as a jam recovery setting and selection of automatic full color/monochrome. The jam recovery setting specifies whether, upon restarting a job after removing a jammed medium, to start printing from the top page of a job or the jammed page. The auto color/monochrome selection specifies whether to enable an option for determining whether the pages are in color or in monochrome one by one. If this option is ON, the color/monochrome determination is automatically performed. If this option is OFF, the color/monochrome determination may be specified by a user.

The document output condition a in a PJL shown in FIG. 5 includes the following items: the number of sets of copies: 2, the type of the requested job: print, the staple option: ON (indicating that the stapling operation is performed), and the punch option: OFF (indicating that the punching operation is not performed).

The first page output condition b may include the following items: the output paper size, the color space (e.g. CMYK, RGB) used by the image information, the plane (e.g. CMYK plane) to be used, the feed tray to be used; the type of the medium, the number of tones to represent the image, and whether to be printed on the front page or the back page in the double-sided printed mode.

The first page output condition b may further include items such as a limitless sheet feeding setting and a page count setting. The limitless sheet feeding setting specifies whether to, in the case of printing images on sheets of a predetermined size but there is no sheet in the selected feed tray, feed sheets of the predetermined size from another tray. The page count setting specifies whether to count the number of printed pages. The number of the printed pages may be necessary information for charging a printing fee based on the number of the printed pages.

The first page output condition b may further include items such as a processing conditions for processing an image. The processing conditions may include settings for processing operations such as rotating, combining, scaling, white/black reversing, negative/positive processing, mirror inverting, color correction, and page sorting. The page sorting operation is performed for, e.g., in the case of printing plural images (pages) in each sheet and stapling the sheets at the center (saddle-stitch) in the form of a book, sorting the images such that the images are arranged in the order of pages when in the form of a book.

The first page document output condition b of FIG. 5 includes the following items: the output paper size for the first page: A4, the feed tray to be used: tray 1, and the processing operation: rotation (90 degrees) (indicating to perform an operation for rotating the image by 90 degrees).

The first page output condition/image information c may include items such as the image size. The first page output condition/image information c of FIG. 5 includes the item indicating the image size, which is 4000×6000 (4000 pixels in length and 6000 pixels in width). The first page output condition/image information c further includes image information as data of the image.

Under the above-described conditions, filters are selected by the filter selecting unit 222 and connected to the printer activity 210a by the tree creating unit 225 to create a job tree. Then the printer activity 210a specifies the processing conditions and output conditions to control the filters, so that a job is performed.

(The Process of Creating a Job Tree for a Print Job and Performing a Print Operation)

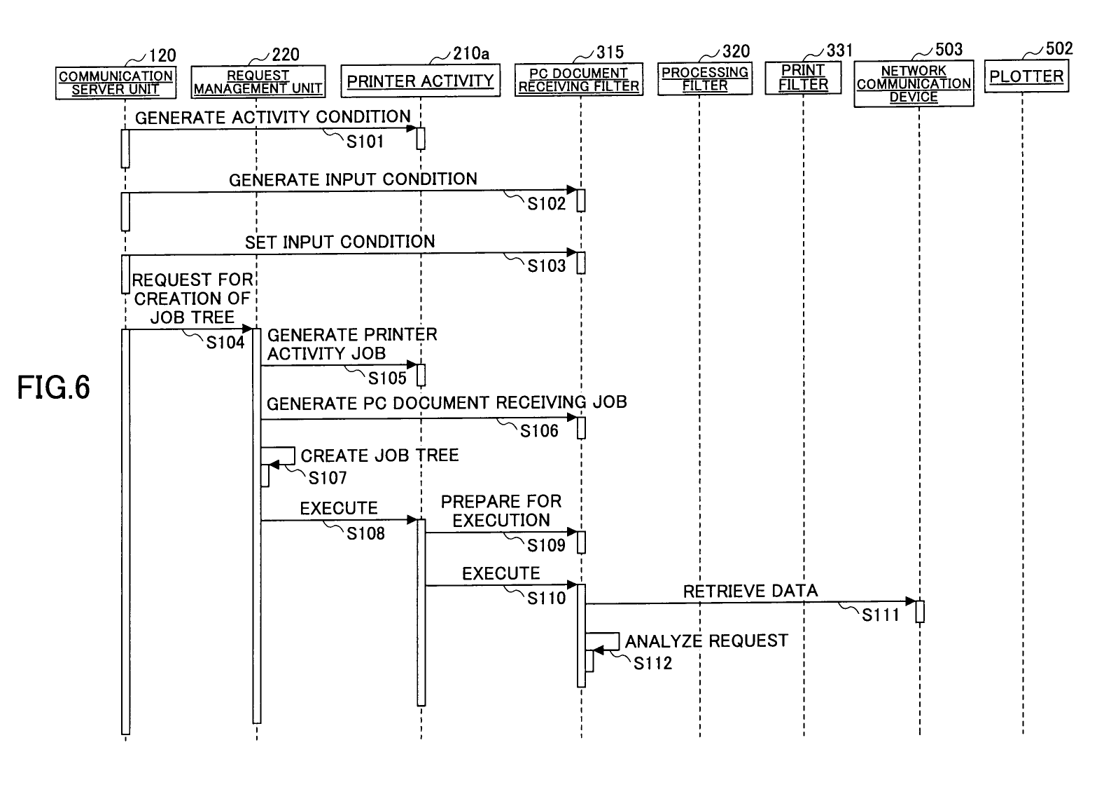

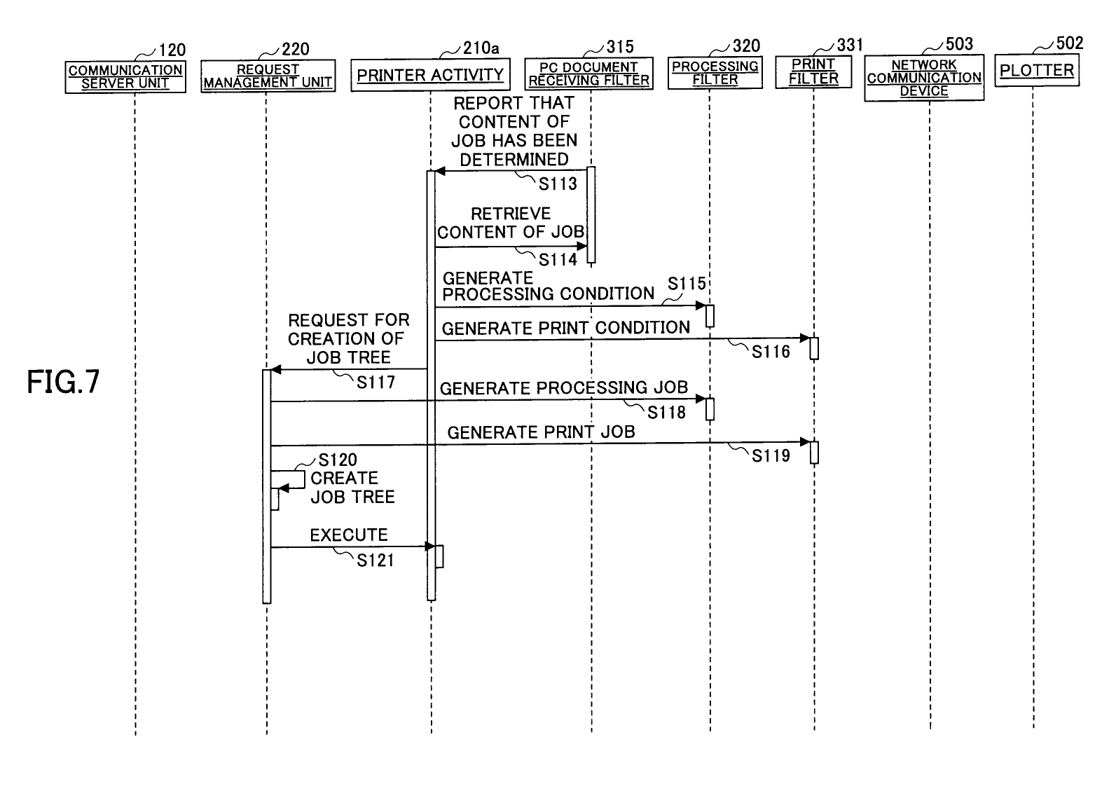

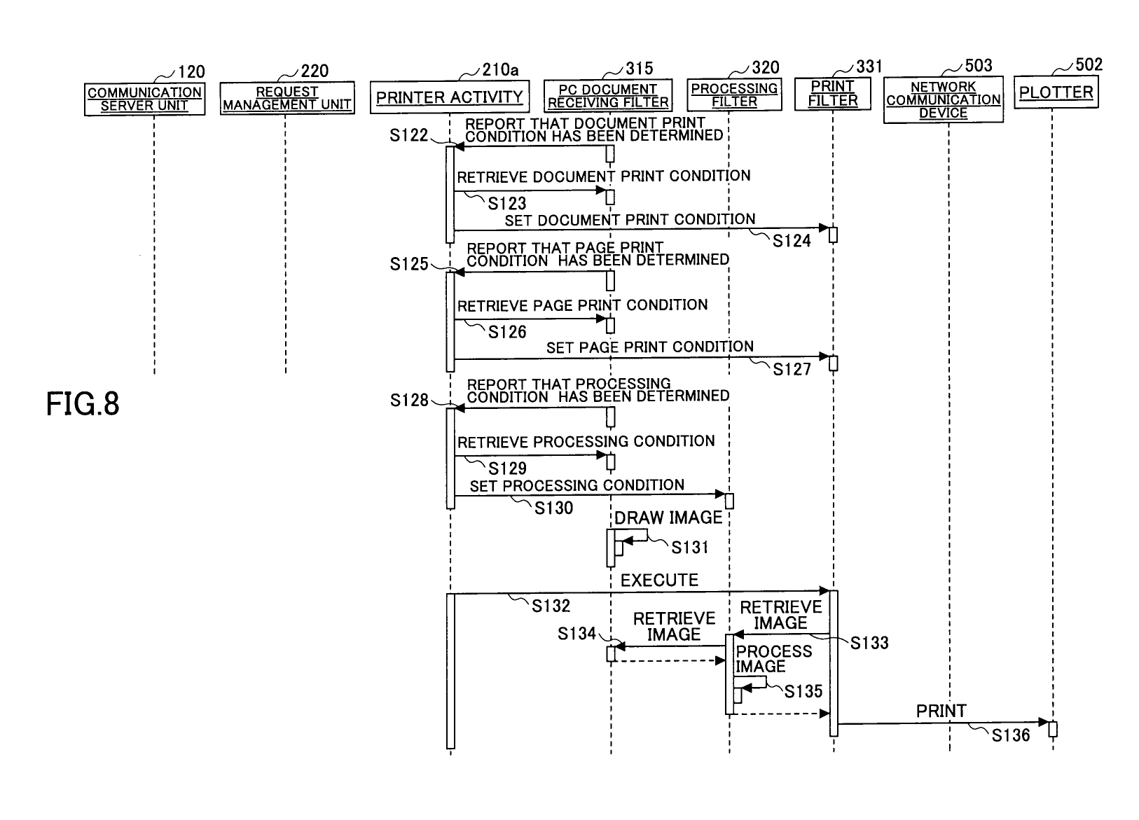

FIGS. 6-8 are sequence diagrams illustrating the process of creating a job tree for a print job and performing a print operation. More specifically, FIG. 6 shows the process of starting reception of a request by the PC document receiving filter 315; FIG. 7 shows the process in which the request management unit 220 creates a job tree; and FIG. 8 shows the process of executing a print job according to the created job tree.

The printer activity 210a of FIGS. 6-8 corresponds to the execution control unit 210 of FIG. 1.

(The Process of Starting Reception of a Request by the PC Document Receiving Filter 315)

Referring to FIG. 6, in Step S101, upon starting reception of a request sent from a PC, the communication server unit 120 sends a request to the printer activity 210a to generate activity conditions. According to the request, the printer activity 210a generates a list of condition items required for controlling a job.

The process proceeds from Step S101 to Step S102, in which the communication server unit 120 sends a request to the PC document receiving filter 315 to generate image input conditions. According to the request, the PC document receiving filter 315 generates a list of condition items required for performing operations that constitute the job.

The process proceeds from Step S102 to Step S103, in which the communication server unit 120 outputs the image input conditions to the PC document receiving filter 315. The image input conditions may include input/output access information, the data type, and other settings. The input/output access information indicates, for example, devices to be accessed as the destination to which data are input and the source from which data are output. The data type indicates, e.g., a request for a job request described in a PDL or a request for a job for sending facsimile from a PC. Other settings may include the type of the language of the request, and the character codes.

The process proceeds from Step S103 to Step S104, in which the communication server unit 120 sends a request to the request management unit 220 to create a job tree. Then in Step S105, the request management unit 220 sends a request to the printer activity 210a to create a logical framework of an operation to be performed by the printer activity 210a. In response to this request, the printer activity 210a creates a logical framework of an operation of a printer activity. Thus, the printer activity 210a is enabled to perform the operation.

To create a logical framework of an operation is, for example, in the case of a processing unit provided as a software program, to generate instances. To create a logical framework of an operation may be to load a module that executes the operation into a memory. Further, to create a logical framework of an operation may be to power-on hardware or the like that executes the operation.

The process proceeds from Step S105 to Step S106, in which the request management unit 220 sends a request to the PC document receiving filter 315 to create a logical framework of an operation for receiving a document from a PC. In response to this request, the PC document receiving filter 315 creates a logical framework of an operation for receiving a document from a PC. Thus, the PC document receiving filter 315 is enabled to perform the operation.

The process proceeds from Step S106 to Step S107, in which the request management unit 220 connects the printer activity 210a to the PC document receiving filter 315, thereby creating a job tree. The job tree created in Step S107 has a structure as shown in FIG. 4-(A), for example.

The process proceeds from Step S107 to Step S108, in which the request management unit 220 sends a request to the printer activity 210a to execute the operation. Then in Step S109 the printer activity 210a sends a request to the PC document receiving filter 315 to prepare for execution of the operation. In response to this request, the PC document receiving filter 315 prepares for execution of the operation.

The process proceeds from Step S109 to Step S110, the printer activity 210a sends a request to the PC document receiving filter 315 to execute the operation. Then in Step S111, in response to the request send in Step S110, the PC document receiving filter 315 executes the operation. More specifically, the PC document receiving filter 315 sends a request to the network communication device 503 to forward received data, and receives the forwarded data.

The process proceeds from Step S111 to Step S112, where the PC document receiving filter 315 analyzes the data received in Step S111, which is a request described in a PDL.

Steps S111 and S112 may be performed in a pipeline manner. In other words, reception of data in Step S111 and processing of the received data in Step S112 may be repeatedly performed so as to analyze the request.

(The Process of Creating a Job Tree)

Referring to FIG. 7, Step S113 is performed based on the request analyzed by the PC document receiving filter 315 in Step S112 of FIG. 6. For example, Step S113 is performed after the type of the requested job contained in the document output condition a of FIG. 5 is determined to be “print”. In Step S113 the PC document receiving filter 315 reports the printer activity 210a that the content of the job has been determined as a result of the analysis of the request described in a PDL.

The process proceeds from Step S113 to Step S114, in which the printer activity 210a retrieves the content of the job from the PC document receiving filter 315.

The process proceeds from Step S114 to Step S115, in which the printer activity 210a sends a request to the processing filter 320 to generate conditions for processing images. In response to this request, the processing filter 320 generates a list of condition items required for an image processing operation.

The process proceeds from Step S115 to Step S116, in which the printer activity 210a sends a request to the print filter 331 to generate conditions for printing the images. In response to this request, the print filter 331 generates a list of condition items required for an image printing operation.

The process proceeds from Step S116 to Step S117, in which the printer activity 210a sends a request to the request management unit 220 to create (extend) the job tree. In response to this request, Step S118 and Step S119 are performed.

In Step S118, the request management unit 220 sends a request to the processing filter 320 to create a logical framework of the image processing operation. In response to this request, the processing filter 320 creates a logical framework of the image processing operation. Thus, the processing filter 320 is enabled to perform the operation specified by the request.

In Step S119, the request management unit 220 sends a request to the print filter 331 to create a logical framework of the image print operation. In response to this request, the print filter 331 creates a logical framework of the image print operation. Thus, the print filter 331 is enabled to perform the operation specified by the request.

Steps S118 and S119 may be performed asynchronously with each other after Step S117.

After completion of the operations in Steps S118 and S119, the process proceeds to Step S120. In Step S120 the request management unit 220 connects the processing filter 320 and the print filter 331 to the job tree created in Step S107, so that the job tree is extended to include the print job for printing images which are input from the PC. The job tree created in Step S120 has a structure as shown in FIG. 4-(B), for example.

The process proceeds from Step S120 to Step S121, in which the request management unit 220 sends a request to the printer activity 210a to execute the job according to the job tree created in Step S120.

(The Process of Executing a Print Job According to a Created Job Tree)

Referring to FIG. 8, Step S122 is performed asynchronously with the operations shown in FIG. 7. More specifically, Step S122 is performed after the print conditions for the document are determined as a result of progress in the analysis of the request in Step S112 of FIG. 6. The document print conditions are determined when the PC document receiving filter 315 completes analysis of the document output condition a of FIG. 5, for example.

In Step S122 the PC document receiving filter 315 reports to the printer activity 210a that the document print conditions have been determined. Then in Step S123, the printer activity 210a retrieves the document print conditions from the PC document receiving filter 315.

The process proceeds from Step S123 to Step S124, in which the printer activity 210a sends a request to the print filter 331 to set the document print conditions. In response to this request, the print filter 331 sets the document print conditions.

Step S125 is performed asynchronously with Step S122. More specifically, Step S125 is performed after the print conditions for the first page is determined as a result of progress in the analysis of the request in Step S112 of FIG. 6. The print conditions for the first page are determined when the PC document receiving filter 315 completes analysis of the first page output condition b of FIG. 5, for example.

In Step S125 the PC document receiving filter 315 reports the printer activity 210a that the print conditions for the first page have been determined. Then in Step S126 the printer activity 210a retrieves the print conditions for the first page from the PC document receiving filter 315.

The process proceeds from Step S126 to Step S127, in which the printer activity 210a sends a request to the print filter 331 to set the print conditions for the first page. In response to this request, the print filter 331 sets the print conditions for the first page.

Step S128 is performed asynchronously with Steps S122 and S125. More specifically, Step S128 is performed after processing conditions for the first page are determined as a result of progress in the analysis of the request in Step S112 of FIG. 6. The processing conditions for the first page are determined when the PC document receiving filter 315 completes analysis of the first page output condition b of FIG. 5, for example.

In Step S128 the PC document receiving filter 315 reports the printer activity 210a that the processing conditions for the first page have been determined. Then in Step S129 the printer activity 210a retrieves the processing conditions for the first page from the PC document receiving filter 315.

The process proceeds from Step S129 to Step S130, in which the printer activity 210a sends a request to the processing filter 320 to set the processing conditions for the first page. In response to this request, the processing filter 320 sets the processing conditions for the first page.

Step S131 is performed asynchronously with Steps S122, S125, and S128. More specifically, Step S131 is performed when all the image information contained in the first page output condition/image information c is retrieved by the PC document receiving filter 315 with the progress in the analysis of the request in Step S112 of FIG. 6. Alternatively, Step S131 may be performed every time a part of the image information contained in the first page output condition/image information c is retrieved by the PC document receiving filter 315. In Step S131, according to the obtained image information, an image is drawn.

After completion of or asynchronous with the operations in Step S122 through Step S131, in Step S132 the printer activity 210a requests the print filter 331 to perform a print operation.

The process proceeds from Step S132 to Step S133, in which the print filter 331 sends a request to the processing filter 320 to retrieve and process an image. Then in Step S134 the processing filter 320 sends a request to the PC document receiving filter 315 to send an image. In response to this request, the PC document sends the image drawn in Step S131 to the processing filter 320.

The process proceeds from S134 to S135, in which the processing filter 320 processes the image received in Step S134 according to the print filter 331. Then in Step S136 the print filter 331 processes the image received in Step S135 and sends the processed image to the plotter 502. The plotter 502 performs a print operation based on the image processed in Step S136, so that an image is formed on a medium, which is ejected from the MFP 1.

In the processes described with reference to FIGS. 7 and 8, every time a print condition is analyzed by the PC document receiving filter 315, a processing unit corresponding to the analyzed print condition is selected, and the selected unit sets the print condition to perform its operation. In this way, every time a job execution condition is analyzed by the PC document receiving filter 315, a processing unit corresponding to the analyzed execution condition is selected. Further, selected processing units asynchronously perform their operations. Accordingly, it is possible to reduce the time taken from reception of an instruction for execution of a job to completion of the job.

(The Process of Transforming an Input Image into Image Formats Compatible with Image Output Units)

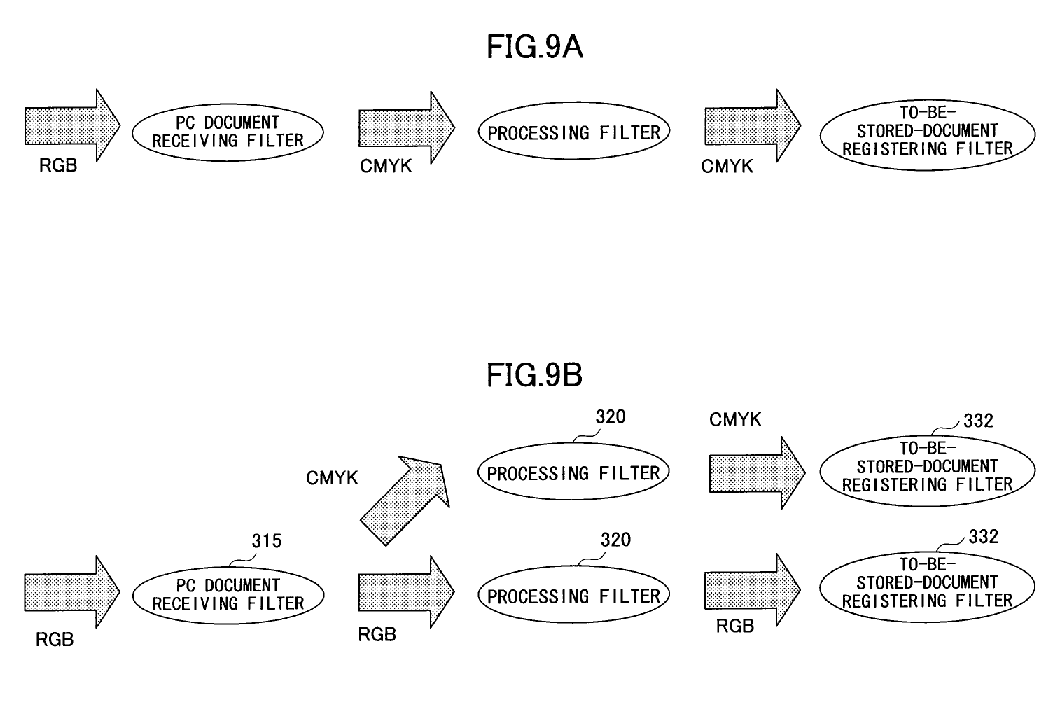

FIGS. 9A and 9B are diagrams each illustrating the process of transforming an input image into an image format(s) compatible with an image output unit(s). In these examples, the image is input from a PC directly or via a network and is stored in a storage device. The image input from the PC is in an RGB image format. FIG. 9A illustrates operations performed by a related-art information processing apparatus. A PC document receiving filter transforms the image into an image format compatible with an image output unit. In this example, in order to increase the productivity in outputting the image by a plotter, the PC document receiving filter is configured to transform the image into a CMYK image format compatible with plotters. Then the image in the CMYK image format is output to a processing filter. The processing filter and a to-be-stored-document registering filter process the image in the CMYK image format, so that the image is stored in a hard disk device.

If the related-art image processing apparatus sends the image input from the PC by facsimile, the stored image is transformed again into an image format compatible with a facsimile device, i.e., an RGB image format, and then the image transformed in the RGB format is sent by the facsimile device. With this configuration, the quality of the image is reduced.

FIG. 9B illustrates operations performed by an information processing apparatus of an embodiment of the present invention. Unlike the related-art image processing apparatus of FIG. 9A, the image processing apparatus of the present embodiment is capable of transforming an image into an image format compatible with an image output unit and another image format compatible with another image output unit. In the example shown in FIG. 9B, the PC document receiving filter 315 processes the RGB image and outputs an image in a CMYK image format. The image may be output in an RGB image format. Then the image is processed by the processing filter 320 and the to-be-stored-document registering filter 332 and stored in the hard disk device 504. Thus the image processing apparatus of this embodiment eliminates the need for re-transforming the stored image.

With this configuration, even when outputting images in different image formats, it is possible to maintain image quality and easily add or modify a function to the image processing apparatus.

(An Example of Combining Images)

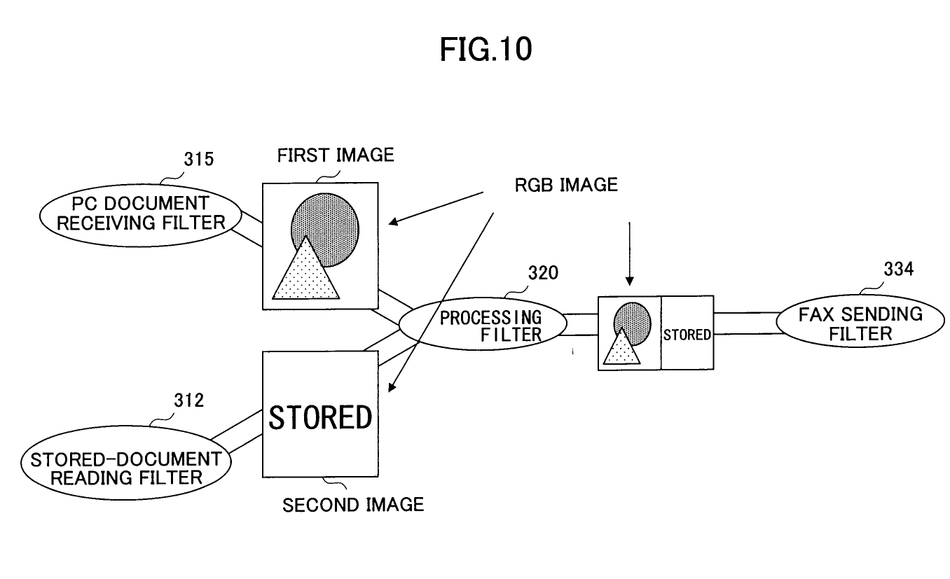

FIG. 10 is a diagram illustrating an operation of combining images. In the example shown in FIG. 10, a first image which is input from a PC and a second image which is read from the hard disk device 504 are combined into a single third image, and the third image is sent by the facsimile device 505 by facsimile transmission.

In FIG. 10, the first image processed by the PC document receiving filter 315 and the second image processed by the stored-document reading filter 312 are processed by the processing filter 320 to generate the third image. The third image generated by the processing filter 320 is processed by the facsimile sending filter 334, so that the third image is sent by facsimile transmission.

In the example of FIG. 10, the first, second, and third images are in the same image format, which is an RGB image format. Images in a versatile format such as the RGB image format can be commonly used by the filters of the MFP 1, thereby preventing reduction in the image quality due to conversion of the image format.

In one embodiment of the present invention, the processing operation unit processes a first image output from a first of the input processing units and a second image output from a second of the input processing units to output a third image. The second image is in the same format as an image format of the first image. With this configuration, it is possible to combine plural images in the same image format into a single third image.

The third image may output in the same format as the first image. This may be convenient especially when combining images in versatile image formats.

The image format of the first image may be an RGB image format or a compressed image format. Then, it is possible to combine images in an RGB image format or combine images in a compressed format.

(An Example of Screens for Selecting an Image Input Unit and an Image Output Unit)

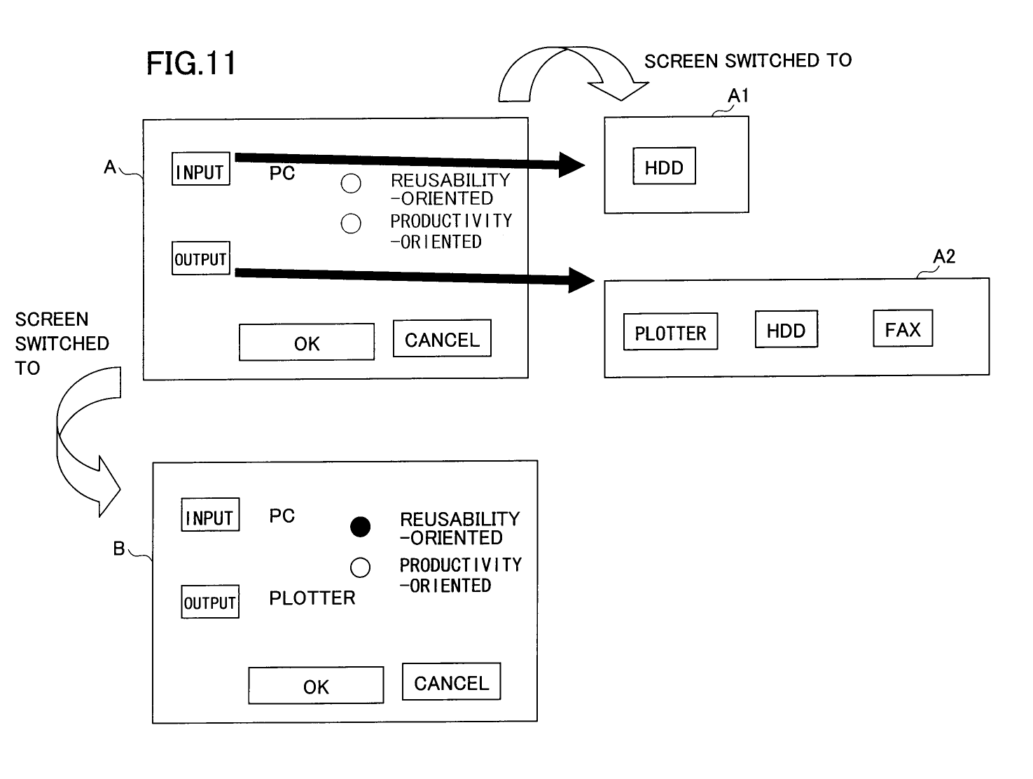

FIG. 11 is an example of screens that prompt a user to select an image input unit and an image output unit. Screens shown in FIG. 11 are displayed on, e.g., the local UI unit 110 of the user interface section 100 or a client PC connected to the communication server unit 120.

On a screen A, “PC” is selected as the default image input unit. If a user presses an “INPUT” button on the screen A, the screen is switched to a screen A1. The screen A1 is for selecting an image input unit, by displaying a list of input units which are connected to the image processing apparatus 1 and are available for use. In the example of FIG. 11, a hard disk device is available for use and can be selected.

With this configuration, it is possible to process an image input from an image input unit selected by the user.

If a user presses an “OUTPUT” button on the screen A, the screen is switched to a screen A2. The screen A2 is for selecting an image output unit, displaying a list of output units which are connected to the image processing apparatus 1 and are available for use. In the example of FIG. 11, a plotter, a hard disk device, and a facsimile device are available for use, one or more of which can be selected.

With this configuration, it is possible to process an image into an image format compatible with the image output unit selected by the user.

If a PC is selected as an input unit and a plotter is selected as an image output unit on the screen A, a screen B is displayed, for example. On the screen B, an option selection field including a “reusability-oriented” option and a “productivity-oriented” option is enabled. This option selection field is used for selecting an image format. For example, if the “reusability-oriented” option is selected, a versatile image format such as an RGB image format is selected. If the “productivity-oriented” option is selected, an image format such as a CMYK image format compatible with predetermined image output units is selected.

This option selection field may be enabled in the case where selection of an image format is allowed. Selection of an image format is allowed when, for example, a hard disk device is selected as the image output unit.

With this configuration, it is possible to output an image in an image format selected by the user.

(The Process of Selecting Filters and Generating a Job)

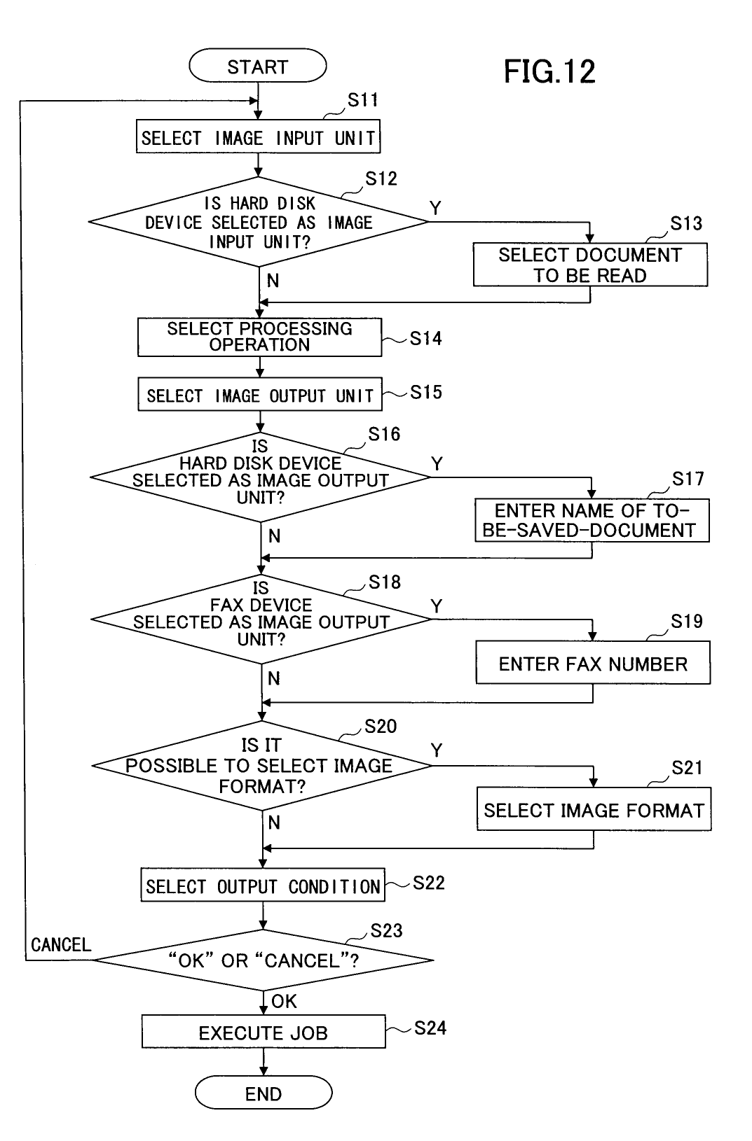

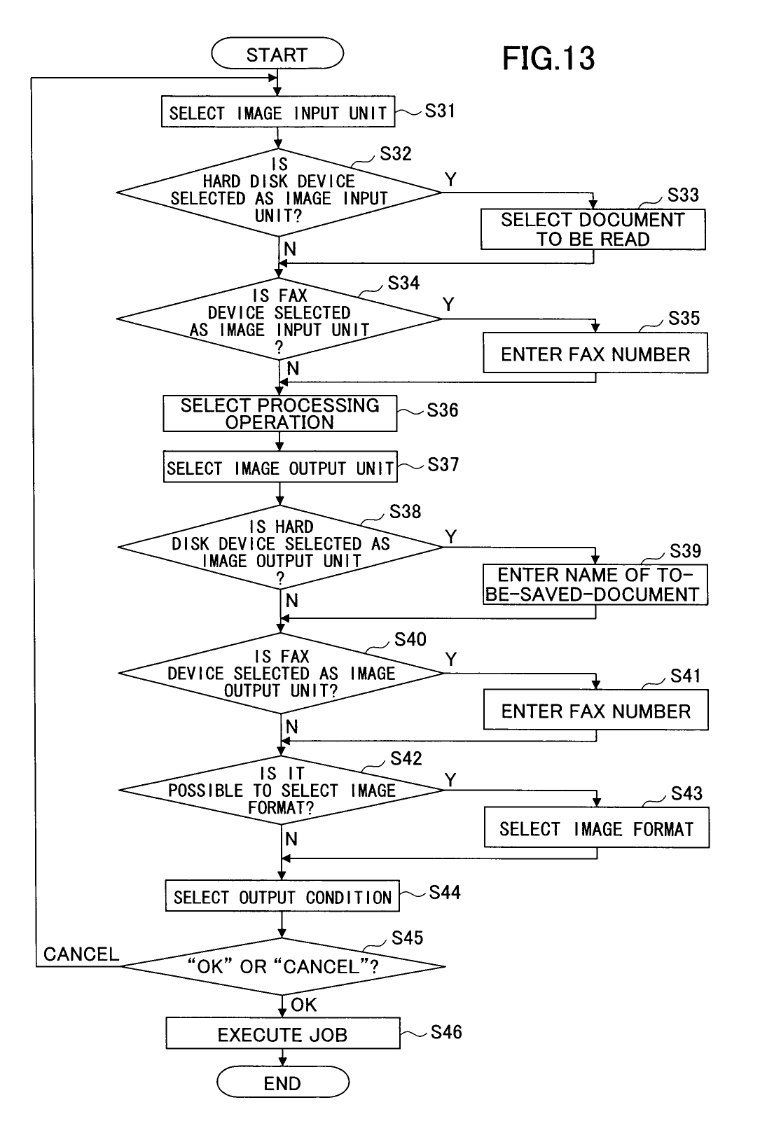

FIGS. 12 and 13 are flowcharts each illustrating the process of determining the content of a job according to selections by a user on the screens of FIG. 11, etc. In the example shown in FIG. 12, the hard disk device 504 that reads data is provided as an image input unit. The hard disk device 504 to which data are output and the facsimile device 505 that sends data by facsimile transmission are provided as image output units. In the example shown in FIG. 13, the facsimile device 505 that receives data by facsimile transmission is further provided as an image input unit.

In FIGS. 12 and 13, information input by a user is obtained by the local UI unit 110 or the communication server unit 120 unless otherwise specified.

Referring to FIG. 12, in Step S11, for example, when a user selects an image input unit on the screen A1 of FIG. 11, the device selecting unit 221 selects the image input unit. Then in Step S12, the device selecting unit 221 determines whether the image input unit selected in Step S11 is the hard disk device 504. If the selected image input unit is the hard disk device 504, the process proceeds to Step S13. If not, the process proceeds to Step S14.

In Step S13, when the user selects a document to be read by entering the path name, etc., of the document, the request management unit 22 obtains the path name, etc. Then the process proceeds to Step S14.

In Step S14, when the user selects or enters the content of a processing operation, the request management unit 22 obtains the content of the processing operation.

The process proceeds from Step S14 to Step S15, in which, for example, when the user selects an image output unit on the screen A2 of FIG. 11, the device selecting unit 221 selects the image output unit. The process proceeds from Step S15 to Step S16, in which the device selecting unit 221 determines whether the image output unit selected in Step S15 is the hard disk device 504. If the selected image output unit is the hard disk device 504, the process proceeds to Step S17. If not, the process proceeds to Step S18.

In Step S17, when the user enters the name with which the document is to be stored, etc., the request management unit 22 obtains the name with which the document is to be stored, etc. Then the process proceeds to Step S18.

In Step S18 the device selecting unit 221 determines whether the image output unit selected in Step S15 is the facsimile device 505. If the selected image output unit is the facsimile device 505, the process proceeds to Step S19. If not, the process proceeds to Step S20.

In Step S19, when the user enters the facsimile number of a destination facsimile machine, the request management unit 22 obtains the facsimile number. Then the process proceeds to Step S20.

In Step S20 the request management unit 22 determines whether there are plural image formats compatible with a job based on the image input unit selected in Step S11, the image format of the image contained in the document data corresponding to the path name entered in Step S13, the image output unit selected in Step S15, or the like. If there are plural compatible image formats, the process proceeds to Step S21. If not, the process proceeds to Step S22.

In Step S21, for example, when the user selects one of the image formats on the screen B of FIG. 11, the device selecting unit 221 obtains the selection of the image format. Then the process proceeds to Step S22.

In Step S22, when the user enters an output condition for outputting the image, the request management unit 22 obtains the output condition.

The process proceeds from Step S22 to Step S23, in which the request management unit 22 determines whether an “OK” button or a “Cancel” button as shown in the screen B of FIG. 11 is selected by the user. If the “OK” button is pressed, the process proceeds to Step S24. If the “Cancel” button is pressed, the process returns to Step S11. If neither the “OK” button nor the “Cancel” button is pressed, the request management unit 22 may wait for either one of the buttons to be pressed. After waiting for a predetermined time period, the process may return to Step S11.

In Step S24, the request management unit 22, the execution control unit 21, etc., execute the job according to the information and conditions entered or selected in Step S11 through Step S23.

Referring to FIG. 13, Step S31 through Step S33 are the same as Step S11 through Step S13 of FIG. 12 and are not described herein.

In Step S34 of FIG. 13, the device selecting unit 221 determines whether the image input unit selected in Step S31 is the facsimile device 505. If the selected image input unit is the facsimile device, the process proceeds to Step S35. If not, the process proceeds to Step S36.

In Step S35, when the user enters the facsimile number of the source facsimile machine, the request management unit 22 obtains the facsimile number.

Then, the process proceeds to Step S36 and the subsequent steps. Step S36 through Step S45 are the same as Step S14 through Step S23 of FIG. 12 and are not described herein.

In step S46, the request management unit 22, the execution control unit 21, etc., execute the job according to the information and conditions entered or selected in Step S31 through Step S45. It is to be noted that in Step S34 if the facsimile device 505 is selected as an image input unit, execution of the job is suspended until the facsimile is received.

(The Configuration of a Computer)

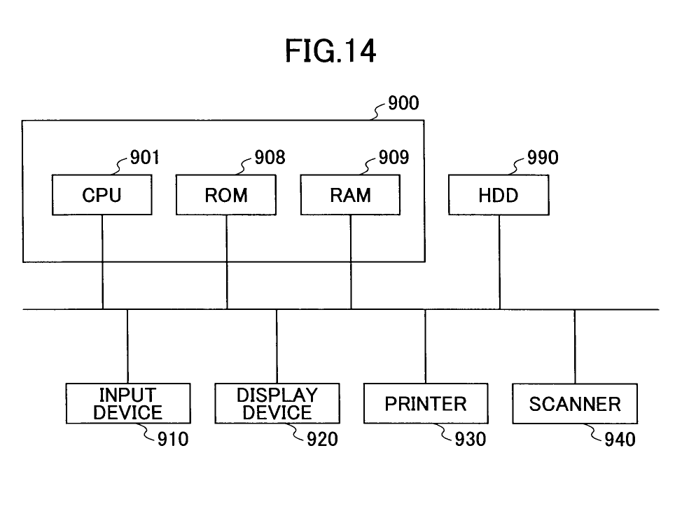

FIG. 14 is a diagram showing the configuration of a computer 14 as an image processing apparatus of an embodiment of the present invention. The computer of FIG. 14 includes a main processing unit 900, an input device 910, a display device 920, a printer 930, a scanner 940, and an HDD 990. The main processing unit 900 performs main computer functions, and includes a CPU 901, a ROM 908, and a RAM 909. The CPU 901 reads a computer program from the ROM 908, loads the computer program into the RAM 909, and executes the computer program. The ROM 908 is a non-volatile memory storing computer programs, such as programs to be executed by the CPU 901, and parameters necessary to control the image processing apparatus. The RAM 909 is a working memory used when the CPU 901 executes operations.

The input device 910 may include, e.g., a keyboard and is used by a user for inputting instructions. The display device 920 displays, for example, the computer status. The printer 930 prints images on a recording medium. The scanner 940 optically scans images on a recording medium. The HDD 990 stores data such as image data.

The computer programs can be stored in the HDD 990, the ROM 908, and a recording medium that can be loaded into a drive unit (not shown).

The corresponding relationships between the elements in the accompanying claims and the elements in the preferred embodiments are as follows. An output processing unit in the claims corresponds to the output filter or the output processing unit in the embodiments. An input processing unit corresponds to the input filter or the input processing unit. A selecting unit corresponds to the device selecting unit. A processing operation unit corresponds to the processing filter or the processing operation unit. An image generating unit corresponds to the preview filter.

The present invention is not limited to the foregoing embodiments, and variations and modifications may be made without departing from the scope of the present invention.

The present application is based on Japanese Priority Application No. 2007-053289 filed on Mar. 2, 2007, with the Japanese Patent Office, the entire contents of which are hereby incorporated by reference.

What is claimed is:

1. An image processing apparatus comprising:
plural output processing units one for each of different image output units; and
an input processing unit that processes image data input from an image input unit to output an image in an image format compatible with one of the image output units.

2. The image processing apparatus as claimed in claim 1, wherein the input processing unit is provided one for each of different image input units.

3. The image processing apparatus as claimed in claim 2, further comprising:
a selecting unit by which said one of the image output units is selected.

4. The image processing apparatus as claimed in claim 3, wherein, if plural of the image output units are selected by the selecting unit which image output units are compatible with different image formats, the input processing unit outputs plural images in said different image formats compatible with the selected image output units.

5. The image processing apparatus as claimed in claim 2, further comprising:
a processing operation unit that processes the image output from one of the input processing units.

6. The image processing apparatus as claimed in claim 5, wherein the processing operation unit processes the image in the image format compatible with the one of the image output units.

7. The image processing apparatus as claimed in claim 5, wherein the processing operation unit processes a first image output from a first of the input processing units and a second image output from a second of the input processing units to output a third image, the second image being in the same image format as the image format of the first image.

8. The image processing apparatus as claimed in claim 7, wherein the third image is in the same image format as the image format of the first image.

9. The image processing apparatus as claimed in claim 7, wherein the image format of the first image is an RGB image format or a compressed image format.

10. The image processing apparatus as claimed in claim 3, wherein when the image input unit outputs the image in the image format compatible with a predetermined one of the image output units, the image output unit selected by the image selecting unit is the predetermined one of the image output units.

11. The image processing apparatus as claimed in claim 10,
wherein the predetermined one of the image output units is a plotter; and
the image format compatible with the predetermined one of the image output units is a CMYK image format or a non-compressed image format.

12. The image processing apparatus as claimed in claim 3, further comprising:
a screen generating unit that generates a selection screen on which said one of the image output units is selected.

13. The image processing apparatus as claimed in claim 12, wherein the screen generating unit further generates a screen on which said image input unit is selected.

14. The image processing apparatus as claimed in claim 12, wherein, if the image output unit selected by the selecting unit is compatible with plural image formats, the screen generating unit further generates a screen on which one of said compatible image formats is selected as the image format in which the image is output.

15. An image processing method comprising:
an input processing step of processing input image data to output an image in an image format compatible with one of different image output units; and
an output processing step of outputting the image to said one of image output units.

16. The image processing method as claimed in claim 15, further comprising:
a screen generating step of generating a selection screen on which said one of image output units is selected.

17. A computer-readable recording medium storing a program, the program including computer-executable instructions for executing an image processing method comprising:
an input processing step of processing input image data to output an image in an image format compatible with one of different image output units; and
an output processing step of outputting the image to said one of the image output units.

18. The computer-readable recording medium as claimed in claim 17, wherein the image processing method further comprising:
a screen generating step of generating a selection screen on which said one of the image output units is selected.
